(19) United States
(12) Patent Application Publication
(10) Pub. No.: US 2023/0100723 A1
(43) Pub. Date: Mar. 30, 2023

(54) CONTROL DEVICE AND CONTROL METHOD FOR MACHINE TOOL

(71) Applicant: FANUC CORPORATION, Yamanashi (JP)

(72) Inventor: Nobuhito OONISHI, Yamanashi (JP)

(21) Appl. No.: 17/909,394

(22) PCT Filed: Mar. 5, 2021
(86) PCT No.: PCT/JP2021/008727

§ 371 Date: Sep. 5, 2022

(30) Foreign Application Priority Data
Mar. 6, 2020 (JP) 2020-038330

(51) Int. Cl. B23Q 27/00; B23Q 15/08; B23Q 15/12; B23C 3/04

(52) U.S. Cl. CPC B23Q 27/006; B23Q 15/08; B23Q 15/12; B23C 3/04

(57) ABSTRACT

An oscillation component a×sin(Mωt) (M is the number of sides) that becomes the maximum when a tool cuts the center of a machining surface is superimposed on a reference angular velocity 2ω of the tool. The angular velocity of a tool shaft becomes higher as the tool shaft comes close to the center of the machining surface and becomes the maximum when the tool shaft is at the center of the machining surface. It is possible to adjust the flatness of the machining surface by adjusting an adjustment parameter a of the oscillation component a×sin(Mωt).

### RELATED APPLICATIONS

The present application is a National Phase of International Application No. PCT/JP2021/008727 filed Mar. 5, 2021, which claims priority to Japanese Patent Application No. 2020-038330, filed Mar. 6, 2020.

### TECHNICAL FIELD

The present invention relates to a control device and a control method for a machine tool that performs polygon turning.

### BACKGROUND ART

Conventionally, there has been polygon turning to process a workpiece into a shape of a polygon by rotating a tool and the workpiece at a constant ratio. In polygon turning, each tool edge draws an elliptical orbit about a workpiece. If the rotation ratio of a workpiece and a tool and the number of tools are changed, the phase or the number of ellipses changes, and accordingly, the workpiece can be processed into a polygon such as a quadrangle or a hexagon.

FIG. 8A illustrates a motion path of a tool relative to a workpiece when the workpiece center is defined as the origin. In this example, the rotation ratio of the workpiece and the tool is 1:2, and the number of tools is two. The motion path of a tool T1 relative to the workpiece is orbit 1, and the motion path of a tool T2 relative to the workpiece is orbit 2. For one turn of the workpiece, the two tools T1 and T2 draw the elliptical orbit 1 and the elliptical orbit 2 around the workpiece, and a quadrangle is formed on the workpiece surface. FIG. 8B illustrates a case where the rotation ratio is 1:2 and the number of tools is three. In this case, the three tools draw elliptical orbits around a workpiece, and when the tools cut the workpiece along these orbits, a hexagon is formed on the workpiece surface.

Since polygon turning is to form a polygon by using a combination of ellipses, a resulted cut surface has a shallow curve. Thus, polygon turning is unsuitable for such high-precision machining that requires high flatness. The advantage of polygon turning is in a shorter machining time than is required for polygon turning using a milling machine or the like. Polygon turning is used for machining of a member that does not require high precision in practical use (such as a head of a bolt or a bit of a driver).

One of the methods for increasing the flatness in polygon turning is to increase the diameter of tools. However, the size of a tool mechanism is limited. Conventionally, as a technique to reduce the diameter of a tool body, a known technique is to provide a housing part for a cutting insert to a cutter body, house the cutting insert in the housing part, and adjust the position of the cutting insert by using a fixing bolt and a positioning bolt. For example, see Patent Literature 1.

Further, there is a technique to move a rotation shaft to process a workpiece into any shape. For example, in Patent Literature 2, a first spindle and a second spindle are rotated at different rotational rates, and the first spindle and the second spindle are shifted in a direction of a virtual straight line based on a phase difference for every first cycle to process the workpiece surface into any shape.

### CITATION LIST

### Patent Literature

Patent Literature 1: Japanese Patent Application Laid-Open No. 2018-140482

Patent Literature 2: Japanese Patent Application Laid-Open No. 2015-79348

### SUMMARY OF INVENTION

### Technical Problem

Although the size of a cutter body can be reduced in Patent Literature 1, tools protrude out of the cutter body, which does not mean that the tool diameter is reduced.

In Patent Literature 2, to process a workpiece into a desired shape, complex control is required such as motion of a first spindle and a second spindle in accordance with a phase difference between the spindles.

In the field of polygon turning, there is a demand for a technique to shape a machining surface without changing the machine tool mechanism.

### Solution to Problem

One aspect of the present invention is a control device that controls polygon turning to form a polygon on a workpiece surface, and the control device includes: a workpiece command generation unit that generates a command of an angular velocity of the workpiece; and a tool command generation unit that generates a command of an angular velocity of a tool, and the angular velocity of the tool relative to the angular velocity of the workpiece is increased or decreased by adjustment of both or one of the angular velocity of the workpiece and the angular velocity of the tool.

Another aspect of the present invention is a control method of controlling polygon turning to form a polygon on a surface of a workpiece surface by rotating the workpiece and a tool simultaneously, and the control method includes: adjusting both or one of an angular velocity of the workpiece and an angular velocity of the tool so as to increase or decrease the angular velocity of the tool relative to the angular velocity of the workpiece;

generating a command of the angular velocity of the workpiece; and generating a command of the angular velocity of the tool.

### Advantageous Effects of Invention

According to one aspect of the present invention, it is possible to shape a machining surface without changing the machine tool mechanism.

### BRIEF DESCRIPTION OF DRAWINGS

FIG. 1 is a hardware configuration diagram of a control device in the present disclosure.

FIG. 2 is a block diagram of the control device in the present disclosure.

FIG. 3 is a diagram illustrating conventional polygon turning.

FIG. 4 is a diagram illustrating angular velocity oscillation in the present disclosure.

FIG. 5A is a diagram illustrating the shape of a machining surface in the conventional polygon turning.

FIG. 5B is a diagram illustrating the shape of a machining surface when an adjustment parameter a is set to 0.1.

FIG. 6A is a diagram illustrating the shape of a machining surface when the adjustment parameter a is set to 0.3.

FIG. 6B is a diagram illustrating the shape of a machining surface when the adjustment parameter a is set to 0.5.

FIG. 7 is a flowchart illustrating a polygon turning method of the present disclosure.

FIG. 8A is a diagram illustrating an orbit of a tool when a quadrangle is formed on a workpiece surface in the conventional polygon turning.

FIG. 8B is a diagram illustrating an orbit of a tool when a hexagon is formed on a workpiece surface in the conventional polygon turning.

### DESCRIPTION OF EMBODIMENTS

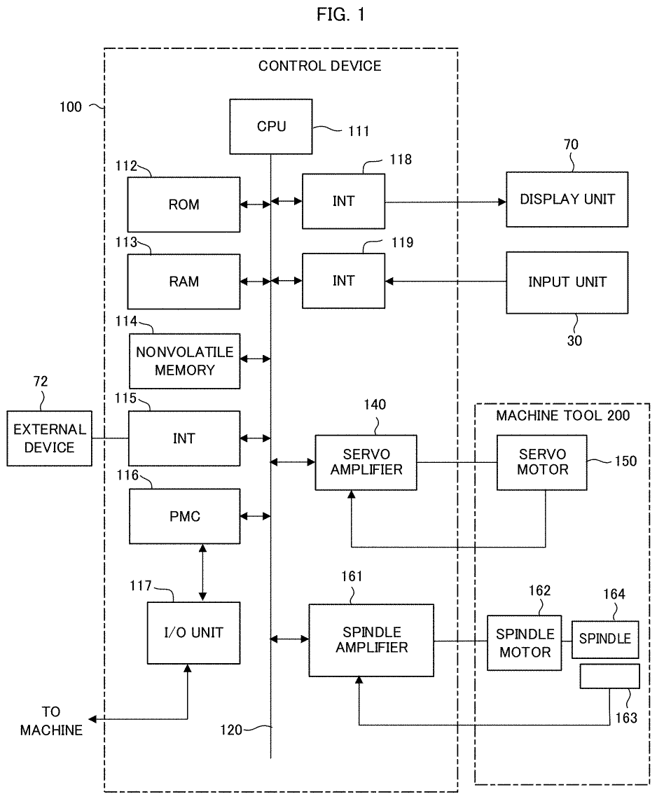

An example of a control device 100 of the present disclosure will be illustrated below. As illustrated in FIG. 1, the control device 100 includes a CPU 111 that controls the overall control device 100, a ROM 112 that stores a program or data, and a RAM 113 into which data is temporarily loaded, and the CPU 111 reads a system program stored in the ROM 112 via a bus 120 and controls the overall control device 100 in accordance with the system program.

A nonvolatile memory 114 is backed up or the like by a battery (not illustrated), for example, and the storage state is maintained even when the control device 100 is powered off. The nonvolatile memory 114 stores a program loaded from an external device 72 via an interface 115, 118, or 119 or various data acquired from a user operation input via an input unit 30 or acquired from each unit of the control device 100, a machine tool 200, or the like (for example, a setting parameter, sensor information, or the like).

The interface 115 is an interface 115 for connecting the control device 100 and the external device 72 such as an adaptor to each other. A program, various parameters, or the like are loaded from the external device 72 side. Further, a program, various parameters, or the like modified in the control device 100 can be stored in an external storage unit via the external device 72. A programmable machine control (PMC) 116 performs input and output of a signal with the machine tool 200, a robot, and a device such as a sensor attached to the machine tool 200 or the robot via an I/O unit 117 and thereby controls the same by using a sequence program built in the control device 100.

On a display unit 70, an operation screen of the machine tool 200, a display screen indicating the operation status of the machine tool 200, or the like are displayed. The input unit 30 is formed of an MDI, an operation panel, a touch panel, or the like and passes operation input made by a worker to the CPU 111.

The servo amplifier 140 controls respective shafts of the machine tool 200. The servo amplifier 140 drives a servo motor 150 in response to receiving a command about the amount of shaft motion from the CPU 111. The servo motor 150 have a built-in position/speed detector and feed a position/speed feedback signal from the position/speed detector back to the servo amplifier 140 to perform feedback control of the position/speed. A tool shaft is attached to the servo motor 150. A plurality of tools T for performing polygon turning are attached to the tool body.

A spindle amplifier 161 drives a spindle motor 162 in response to receiving a spindle rotation command for a spindle 164 of the machine tool 200. The power of the spindle motor 162 is transmitted to the spindle 164 via a gear, and the spindle 164 rotates at an instructed rotational rate. A position coder 163 is coupled to the spindle 164, the position coder 163 outputs feedback pulses in synchronization with the spindle 164, and the feedback pulses are read by the CPU 111.

The workpiece W is attached to the spindle 164. The axis directions of the spindle 164 and the tool shaft are parallel, and the spindle 164 and the tool shaft rotate at a predetermined rotation ratio. When the spindle 164 and the tool shaft rotate simultaneously, the tool T attached to the tool shaft cuts the workpiece surface, and a polygon is formed on the workpiece surface.

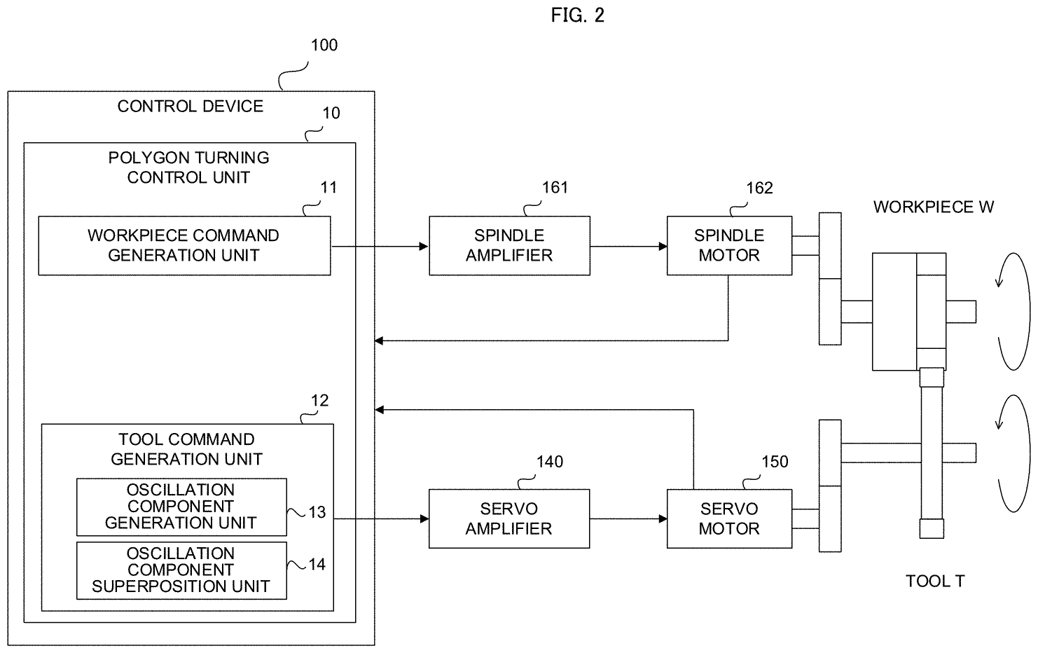

FIG. 2 is a block diagram of the control device 100 having an adjustment function of polygon turning. The function in this block diagram is implemented when the CPU 111 executes a program stored in a storage device such as the ROM 112.

The control device 100 includes a polygon turning control unit 10. The polygon turning control unit 10 includes a workpiece command generation unit 11 that generates a rotation command for the workpiece shaft, and a tool command generation unit 12 that generates a rotation command for the tool shaft.

The workpiece command generation unit 11 generates a rotation command for the spindle 164. The workpiece command generation unit 11 generates a command for rotating the spindle 164 at a constant angular velocity ω and outputs the command to the spindle amplifier 161. The spindle amplifier 161 controls the spindle motor 162 in accordance with the command from the workpiece command generation unit 11. The spindle motor 162 rotates the spindle 164 at a constant angular velocity ω. Accordingly, the workpiece W attached to the spindle 164 rotates at the constant angular velocity ω.

The tool command generation unit 12 includes an oscillation component generation unit 13 and an oscillation component superposition unit 14. The oscillation component generation unit 13 generates an oscillation component to be superimposed on the angular velocity of the tool T. While a specific calculation method will be described later, an oscillation component is determined from the phases of the workpiece W and the tool T, the rotation ratio between the workpiece W and the tool T, the angular velocities of the workpiece W and the tool T, the number of tools T, or the like. The oscillation component superposition unit 14 calculates a corrected angular velocity by superimposing an oscillation component generated by the oscillation component generation unit on a reference angular velocity of the tool T. In an example described later, the reference angular velocity of the tool T is 2ω, and the oscillation component is a×sin(Mωt) (M is the number of sides of a polygon).

The oscillation component superposition unit 14 calculates a corrected angular velocity by superimposing an oscillation component on the reference angular velocity. The tool command generation unit 12 outputs a corrected angular velocity to the servo amplifier 140. The servo amplifier 140 controls the servo motor 150 in accordance with a command from the tool command generation unit 12. The servo motor 150 rotates the tool T at the corrected angular velocity.

Note that the reference angular velocity means a tool angular velocity before adjustment to rotate the tool T in the conventional polygon turning. In the conventional polygon turning, the tool T is rotated at a constant angular velocity. In the present disclosure, an oscillation component is superimposed on the reference angular velocity to change the rotational rate of the tool T, and thereby the flatness of a machining surface is adjusted.

### Conventional Polygon Turning

First, the conventional polygon turning will be described.

In the conventional polygon turning, the angular velocities of the tool shaft and the workpiece shaft are constant. In the following description, the rotation ratio between the workpiece shaft and the tool shaft is 1:2. That is, when the angular velocity of the workpiece shaft is ω, the angular velocity of the tool shaft is twice, namely, 2ω. When two tools t1 and t2 are attached at a rotation ratio of 1:2, the two tools t1 and t2 each cut the workpiece surface twice for one turn of the workpiece W, and a quadrangle is formed on the workpiece surface. Note that, if the number of tools T is increased to three, the three tools each cut the workpiece surface twice for one turn of the workpiece W, and a hexagon is formed on the workpiece surface.

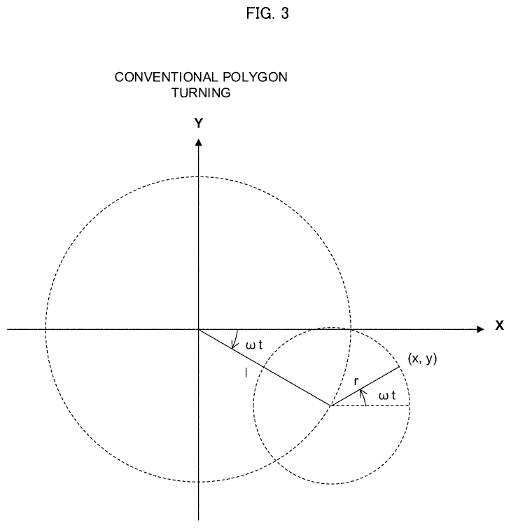

The orbit of a tool edge on the XY orthogonal coordinate system fixed to the workpiece W will be described with reference to FIG. 3. The origin O is the workpiece center. The distance between the centers of the workpiece W and the tool T is denoted as l, and the workpiece radius is denoted as r. When the workpiece W rotates clockwise at an angular velocity ω, the center P of the tool T moves at the angular velocity ω on a circumference of the radius l about the point O. Since the tool T rotates counterclockwise at an angular velocity ω (tool angular velocity 2ω−workpiece angular velocity ω), the position Q (x, y) of the tool edge relative to the workpiece center changes with time t as follows.

x=l cos(−ωt)+r cos(ωt)

y=l sin(−ωt)+r sin(ωt) [Math. 1]

Furthermore, when the tool number is denoted as n (=1, . . . , N; N is the number of tools), since the phase of each tool is shifted by 2π/n, the locus of each tool is as follows.

$${x}_{n} = l cos ( ω t ) + r cos ( ω t + \frac{2 π}{n} ) \qquad [ Math . 2 ]$$

$${y}_{n} = - l sin ( ω t ) + r sin ( ω t + \frac{2 π}{n} )$$

Since the number of tools T is two, the loci (x1, y1) and (X2, y2) of the tool t1 and the tool t2 are as follows, respectively.

x₁=l cos(ωt)+r cos(ωt)

y₁=−sin(ωt)+r sin(ωt)

x₂=l cos(ωt)+r cos(ωt+π)

y₂=−l sin(ωt)+r sin(ωt+π) [Math. 3]

### Generation of Oscillation Component

The tool command generation unit 12 generates an angular velocity that has been corrected by superimposing an oscillation component on the reference angular velocity (hereafter, referred to as a corrected angular velocity).

An oscillation component in the present disclosure is a×sin(Mωt). The value M denotes the number of sides of a polygon, and the oscillation component oscillates at a frequency of a multiple of the number of sides of the workpiece W. The value a denotes an adjustment parameter. A change of the adjustment parameter a changes an adjustment amount of the oscillation component. An increase or decrease of the adjustment parameter a changes how the machining surface is made concave or convex, as described later. When a flat machining surface is desired, an adjustment parameter a which eliminates concave and convex is selected. The adjustment parameter a may be set manually by an engineer, or the maximum value which does not make the machining surface concave may be derived from numerical analysis.

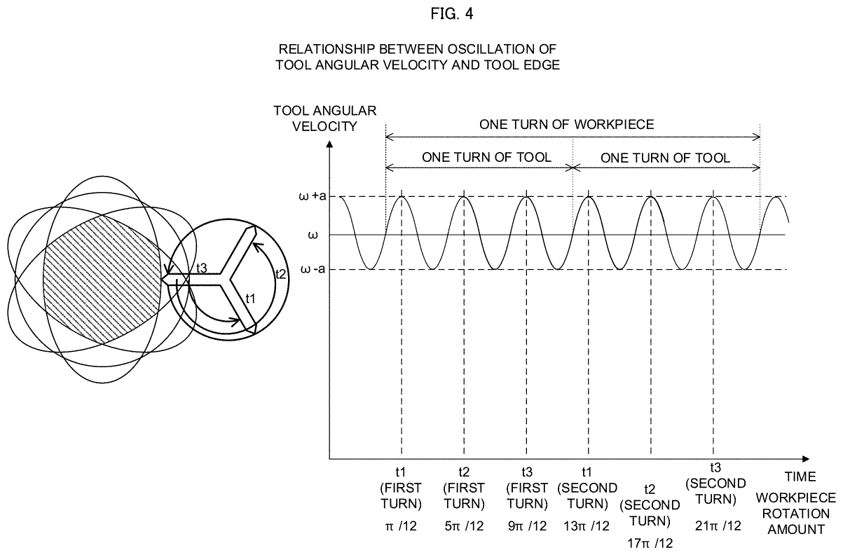

The relationship between the oscillation of the angular velocity of the tool T and the rotation of the workpiece W is illustrated with reference to FIG. 4. In FIG. 4, three tools t1, t2, and t3 are attached to the tool body. Further, the workpiece W and the tool T rotate at a rotation ratio of 1:2, the three tools t1, t2, and t3 each cut the workpiece W twice for one turn of the workpiece W to form a hexagon. As illustrated in FIG. 4, the reference angular velocity ω is constant, and the corrected angular velocity oscillates about ω. The phase of the corrected angular velocity becomes the maximum when the tools t1, t2, and t3 reach the center of the machining surface. The oscillation range of the corrected angular velocity is ω−a to ω+a. The oscillation frequency of the corrected angular velocity is a product of the number of sides and the rotation frequency of the workpiece shaft. In the example of FIG. 4, the corrected angular velocity oscillates six times for one turn of the workpiece W.

The oscillation component a×sin(Mωt) is a sine wave that becomes the maximum when the tool T cuts the center of the machining surface. When an oscillation component is superimposed on the reference angular velocity, the angular velocity of the tool shaft becomes higher as the tool shaft is closer to the center of the machining surface and becomes the maximum when the tool shaft is at the center of the machining surface. In the polygon turning of the present disclosure, superposition of the oscillation component on the reference angular velocity enables adjustment of the cutting rate at or near the center of the machining surface, and it is possible to change the shape of the machining surface.

The number of tools can be changed to any number. The number of tools is N. Since the rotation ratio between the workpiece W and the tool T is typically 1:2, the relationship between the number of machining sides M and the number of tool edges N is M=2N, and the oscillation component is a×sin(2Nωt). The oscillation component corresponds to a sine wave with an amplitude a that oscillates at a product of the reference angular velocity ω of the tool shaft and the number of machining sides. The oscillation component is at the maximum value a when each tool T cuts the center of the machining surface. The locus of each tool n (n=1, 2, . . . ) when the number of tools T is N is as follows.

$${x}_{n} = l cos ( ω t ) + r cos ( ω t + a sin ( 2 N ω t ) + \frac{2 π}{n} ) \qquad [ Math . 4 ]$$

$${y}_{n} = - l sin ( ω t ) + r sin ( ω t + a sin ( 2 N ωt ) + \frac{2 π}{n} )$$

When the two tools (tool t1, tool t2) are used, the loci of the tool t1 and the tool t2, (x1, y1) and (x2, y2), are as follows.

x₁=l cos(ωt)+r cos(ωt+a sin(2Nωt))

y₁=−l sin(ωt)+r sin(ωt+a sin(2Nωt))

x₂=l cos(ωt)+r cos(ωt+a sin(2Nωt)+π)

y₂=−l sin(ωt)+r sin(ωt+a sin(2Nωt)+π) [Math. 5]

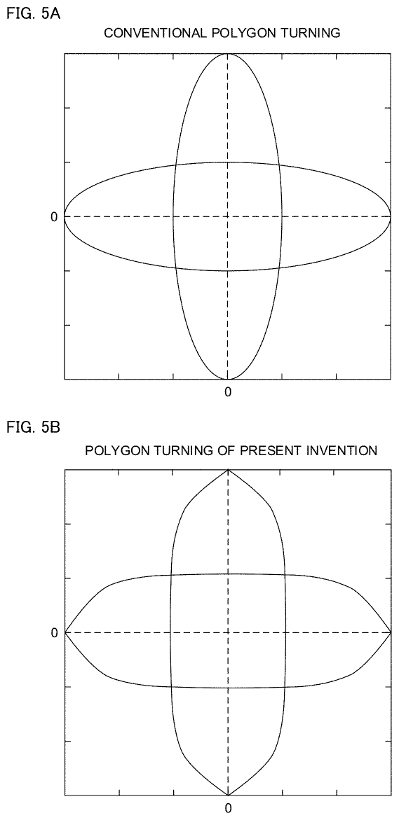

The graphs illustrated in FIGS. 5A and 5B represent results when the above equation is calculated assuming that N=2, l=10, r=5, a=0.1, and ω=20, π/3 (=200 rpm). It can be seen that the flatness of the machining surface of a quadrangle is improved in the polygon turning of the present disclosure (FIG. 5B) compared to the conventional polygon turning (FIG. 5A). The flatness of the machining surface can be changed by adjustment of the value of the adjustment parameter a. The adjustment parameter a may be set manually by an engineer, or the maximum value which does not make the machining surface concave may be derived from numerical analysis.

### Modification of Machining Surface

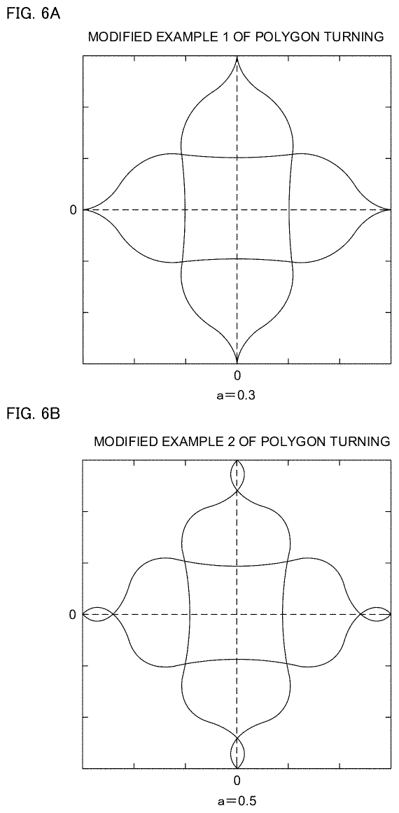

In the polygon turning illustrated in FIGS. 6A and 6B, calculation is made assuming N=2, l=10, r=5, a=0.1, and ω=20π/3 (=200 rpm). A change of the value of a modifies the machining surface. FIG. 6A illustrates a processed shape at a=0.3. An increase of the value of a results in a shape whose center of the machining surface is concave. As illustrated in FIG. 6B, a further increase of the value of a (a=0.5) makes the center of the machining surface more concave. A higher value of the adjustment parameter a results in a higher angular velocity of the tool T relative to the workpiece W at or near the center of the machining surface and therefore a larger concavity of the machining surface. In contrast, a lower value of the adjustment parameter results in a lower angular velocity of the tool T relative to the workpiece W at or near the center of the machining surface and therefore a smaller concavity of the machining surface. If the adjustment parameter a is zero, this results in a slightly convex shape as with the conventional machining. In such a way, it is possible to adjust the workpiece surface shape by increasing or decreasing the angular velocity of the tool relative to the angular velocity of the workpiece.

As described above, the control device 100 of the present disclosure superimposes an oscillation component, which becomes the maximum when the tool edge is at the center of the machining surface, on the reference angular velocity, and thereby increases the angular velocity at or near the center of the machining surface to improve the flatness of the machining surface. By changing the adjustment parameter a of the oscillation component, it is possible not only to adjust the flatness of the machining surface but also to form a concavity in the machining surface.

### Adjustment Method of Machining Surface

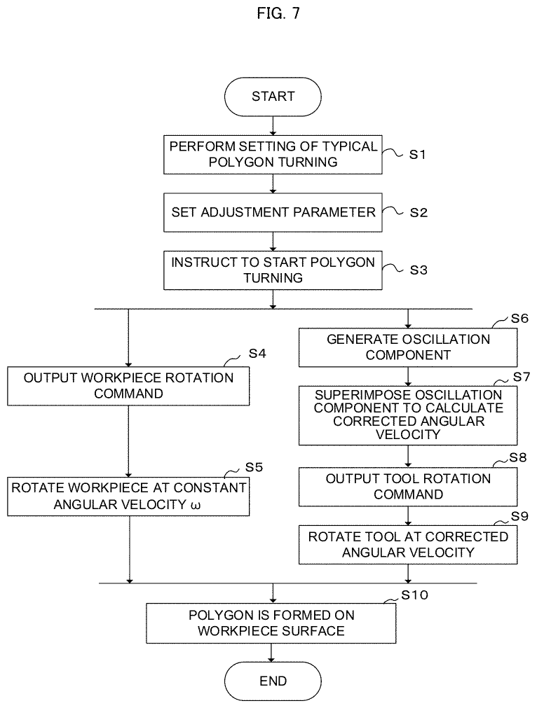

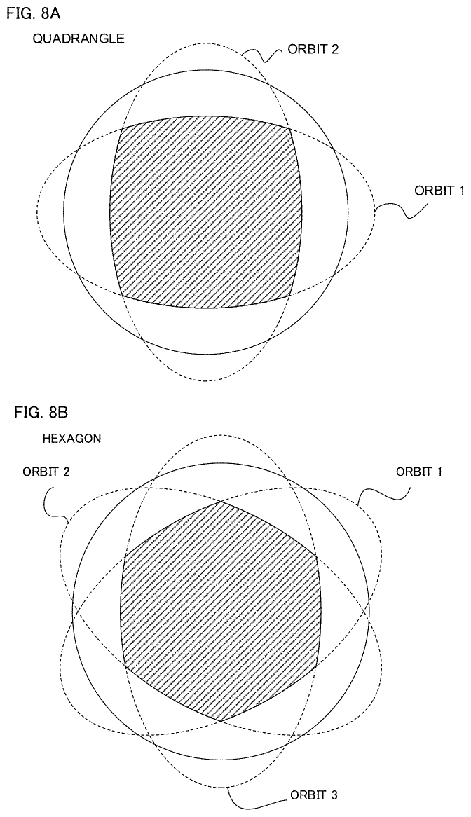

An adjustment method in polygon turning of the present disclosure will be described with reference to the flowchart of FIG. 7. First, the workpiece W and the tool T are attached to the machine tool 200, and the distance between the rotation center of the workpiece W and the center of the tool rotation (1), the tool radius (r), the rotational rate of the workpiece W (ω), and the number of the tools (N) are input to the control device 100 (step S1). The operation so far is the same as the typical polygon turning.

Next, the adjustment parameter a is set (step S2). The engineer of the machine tool 200 observes the flatness of the machining surface while viewing the graph of the equations described above or the like and then sets a suitable adjustment parameter a to the control device. The adjustment parameter a may be manually set by an engineer, or the maximum value which does not make the machining surface concave may be derived from numerical analysis.

When the operator of the machine tool 200 provides a command to start polygon turning (step S3), the workpiece command generation unit outputs a rotation command of the workpiece W to the spindle amplifier 161 (step S4). The spindle motor 162 rotates the workpiece W at a constant angular velocity W in accordance with the control of the spindle amplifier 161 (step S5). At the same time, the oscillation component generation unit 13 generates an oscillation component (step S6), and the oscillation component superposition unit 14 superimposes the oscillation component generated by the oscillation component generation unit 13 on the reference angular velocity (step S7). The tool command generation unit 12 outputs a corrected angular velocity, which is obtained by superimposing the oscillation component on the reference angular velocity, to the servo amplifier (step S8).

The servo motor 150 rotates the tool T at the corrected angular velocity 2ω+a×sin(2Nωt) in accordance with the control from the servo amplifier (step S9). Polygon turning is performed while the tool T is rotated at the correction angular velocity, and thereby a polygon with adjusted flatness is formed on the workpiece surface (step S10).

As described above, in the present disclosure, an oscillation component is superimposed on the reference angular velocity of a tool shaft for polygon turning. The oscillation component becomes the maximum when the tool edge reaches the center of the machining surface. When the oscillation component is superimposed, the rotational rate of the tool shaft becomes higher as the tool edge comes close to the center of the machining surface. Therefore, the cutting distance at or near the machining surface is increased, and the flatness is improved.

The surface shape of the polygon turning changes in response to a change of the value of the adjustment parameter a of the oscillation component a×sin(4ωt). When an increase in the concavity of the machining surface is desired, the value of the adjustment parameter a is increased.

Although a sine wave is used as an oscillation component in the present disclosure, an oscillation component other than a sine wave may be used. Further, although the rotation ratio between the workpiece W and the tool T is 1:2 in the present disclosure, it is also possible to adjust the machining surface by changing the rotation ratio.

Although one embodiment has been described above, the present invention is not limited to the disclosure described above and can be implemented in various forms with addition of a suitable change. For example, although the present disclosure is configured such that the workpiece shaft is the spindle shaft and the tool shaft is the servo shaft, polygon turning between spindles in which both the two shafts are the spindle shafts may be employed.

Further, although an oscillation component is superimposed on the tool shaft to change the angular velocity of the tool T in the present disclosure, the oscillation component is not necessarily required to be superimposed on only the tool shaft. As long as the relative angular velocity between the workpiece shaft and the tool shaft is oscillated, the angular velocity of the workpiece W may be adjusted, or both the angular velocities of the workpiece W and the tool T may be adjusted.

Although the cases of a square and a regular hexagon have been described in the present disclosure, even when the formed shape is not a regular polygon, such a case is included in the present disclosure. For example, in a polygon cutter with two tools, when the phase difference between the tools is 90 degrees instead of 180 degrees, the workpiece shape will be a rhombus instead of a square. The present disclosure is also applicable to another polygon such as a rhombus.

Further, although the example in which the oscillation component is the maximum at the center of the machining surface has been described in the above example, the oscillation component may be suitably changed to improve the flatness.

1. A control device that controls polygon turning to form a polygon on a workpiece surface by rotating a tool and a workpiece simultaneously, the control device comprising:
a workpiece command generation unit that generates a command of an angular velocity of the workpiece; and
a tool command generation unit that generates a command of an angular velocity of the tool,
wherein the angular velocity of the tool relative to the angular velocity of the workpiece is increased or decreased so that a shape of a machining surface is adjusted by adjustment of both or one of the angular velocity of the workpiece and the angular velocity of the tool.

2. The control device according to claim 1, wherein the angular velocity of the tool relative to the angular velocity of the workpiece is increased or decreased at or near the center of the machining surface of the polygon.

3. The control device according to claim 1 further comprising:
an oscillation component generation unit that generates an oscillation component that causes the angular velocity of the tool relative to the angular velocity of the workpiece to be the maximum at or near the center of the machining surface of the polygon; and
an oscillation component superposition unit that superimposes the oscillation component on a workpiece angular velocity or a tool angular velocity before adjustment for the polygon turning.

4. The control device according to claim 3, wherein the oscillation component oscillates at a frequency of a multiple of the number of sides of the polygon with respect to a workpiece angular velocity before adjustment for the polygon turning.

5. The control device according to claim 3, wherein the oscillation component includes an adjustment parameter, and the shape of the machining surface is changed in accordance with the adjustment parameter.

6. The control device according to claim 1, wherein shape adjustment performed on the machining surface improves flatness.

7. A control method of controlling polygon turning to form a polygon on a surface of a workpiece by rotating the workpiece and a tool simultaneously, the control method comprising:
adjusting both or one of an angular velocity of the workpiece and an angular velocity of the tool so as to increase or decrease the angular velocity of the tool relative to the angular velocity of the workpiece;
generating a command of the angular velocity of the workpiece; and
generating a command of the angular velocity of the tool.
